(19) United States
(12) Patent Application Publication
(10) Pub. No.: US 2018/0368588 A1
(43) Pub. Date: Dec. 27, 2018

(54) Rotation Mechanism and Display Supporter

(71) Applicant: Taizhou Chuangxin Electronic Co., Ltd., Taizhou ,Jiangsu (CN)

(72) Inventors: Yong XIA, Taizhou (CN); Bo CHEN, Taizhou (CN)

(73) Assignee: Taizhou Chuangxin Electronic Co., Ltd., Taizhou, Jiangsu (CN)

(21) Appl. No.: 15/577,824

(22) PCT Filed: Oct. 12, 2017
(86) PCT No.: PCT/CN2017/105913

§ 371 Date: Nov. 29, 2017

(30) Foreign Application Priority Data
Jun. 22, 2017 (CN) 201720736333.X

(51) Int. Cl. A47F 5/00; F16M 13/02

(52) U.S. Cl. CPC A47F 5/0087; F16M 13/02; F16M 2200/06; F16M 2200/042; F16M 2200/021

(57) ABSTRACT

Provided are a rotation mechanism and a display supporter. The mechanism includes a holder, a horizontal rotation part and a vertical rotation part. One end of the vertical rotation part is rotationally connected with the holder via a rotation shaft, such that the vertical rotation part rotates about the rotation shaft in a vertical direction. One end of the horizontal rotation part is rotationally connected with the other end of the vertical rotation part via a connection shaft, such that the horizontal rotation part can rotate about the connection shaft in a horizontal direction. During use, a vertical rotation can be achieved by rotating the vertical rotation part around the rotation shaft, and a horizontal rotation can be achieved by horizontally adjusting the horizontal rotation part with a force. The vertical and horizontal rotation parts are integrated together, which facilitates the adjustment and reduces the occupied space.

### CROSS-REFERENCE TO RELATED APPLICATION

The present application claims the priority to Chinese patent application No. 201720736333.X, titled “Rotation Mechanism and Display Supporter”, and filed with the State Intellectual Property Office of the People's Republic of China on Jun. 22, 2016, the content of which is hereby incorporated by reference in its entirety.

### TECHNICAL FIELD

The present application relates to the technical field of supporting parts of displays and rotation mechanisms, and particularly to a rotation mechanism and a display supporter.

### BACKGROUND ART

At present, an electronic computer has become one of the necessary devices in our daily life and work. With a progress of science and technology and a rapid advancement of various computer technologies and network technologies, the development of computer has entered a fast and new era, and plays a more and more important role.

In an existing rotation mechanism of the display supporter, both of a horizontal rotation mechanism and a vertical rotation mechanism are provided separately, thus a rotational adjustment is not easily implemented and certain space is occupied, which is not conducive to the use of the product.

### DISCLOSURE OF THE INVENTION

An object of the present application is to provide a rotation mechanism, so as to solve the technical problem presented in the prior art that both of a horizontal rotation mechanism and a vertical rotation mechanism are provided separately which causes a rotational adjustment to be not easily implemented.

Another object of the present application is to provide a display supporter having the rotation mechanism mentioned above, so as to solve the technical problem presented in the prior art that both of the horizontal rotation mechanism and the vertical rotation mechanism are provided separately which causes the rotational adjustment to be not easily implemented.

To achieve the above objects, the present application provides the following technical solutions.

A first aspect of the present application provides a rotation mechanism configured to be used in a display supporter. The rotation mechanism includes a holder, a horizontal rotation part and a vertical rotation part.

One end of the vertical rotation part is rotationally connected with the holder via a rotation shaft, such that the vertical rotation part rotates about the rotation shaft in a vertical direction. One end of the horizontal rotation part is rotationally connected with the other end of the vertical rotation part via a connection shaft, such that the horizontal rotation part can rotate about the connection shaft in a horizontal direction.

The first aspect of the present application provides the rotation mechanism configured to be used in the display supporter. The rotation mechanism includes the holder, the horizontal rotation part and the vertical rotation part. One end of the vertical rotation part is rotationally connected with the holder via the rotation shaft, such that the vertical rotation part rotates about the rotation shaft in the vertical direction. One end of the horizontal rotation part is rotationally connected with the other end of the vertical rotation part via the connection shaft, such that the horizontal rotation part can rotate about the connection shaft in the horizontal direction. During use, if a vertical rotation is desired, the vertical rotation part is rotated around the rotation shaft to realize the rotation in the vertical direction; and if a horizontal rotation is desired, the horizontal rotation part is adjusted horizontally with a force to carry out a horizontal adjustment. In this way, the vertical rotation part and the horizontal rotation part are integrated together, which facilitates the adjustment and reduces the occupied space.

In the above-mentioned technical solution, furthermore, the vertical rotation part includes one lateral plate, two connection plates and an arc-shaped plate, with the two connection plates perpendicularly connected with two ends of the lateral plate, respectively, and the arc-shaped plate fixedly connected with a middle part of the lateral plate.

Each of the connection plates is provided therein with a first through-hole. The rotation shaft passes through each of a first connection hole in the holder and the first through-holes and is connected with a nut, such that the two connection plates are rotationally connected with the holder.

The arc-shaped plate is provided therein with a second through-hole. The connection shaft passes through a second connection hole of the horizontal rotation part and is connected with a nut.

In any of the above-mentioned technical solutions, furthermore, the holder includes a connection base and legs, with the legs provided at two ends of the connection base. Each of the legs is provided therein with the first connection hole.

In any of the above-mentioned technical solutions, furthermore, an end of each of the legs is provided with a bayonet. A housing of the vertical rotation part is provided thereon with a clamped pillar, with the clamped pillar being in cooperation with the bayonet, such that the housing is connected with the holder.

In any of the above-mentioned technical solutions, furthermore, the rotation shaft is provided thereon with a plurality of torsion springs. One end of each of the torsion springs is stuck in the connection base, and the other end of each of the torsion springs is stuck in the lateral plate.

In any of the above-mentioned technical solutions, furthermore, the horizontal rotation part includes two horizontal plates arranged opposite to each other. The two horizontal plates are connected with each other via two vertical plates, and each of the vertical plates is arranged at an end of edge portion of each of the horizontal plates. Each of the horizontal plates is provided therein with the second connection hole.

In any of the above-mentioned technical solutions, furthermore, the horizontal plates are provided therein with a plurality of insertion holes, and a protective rotation shell is provided on the horizontal plates. The rotation shell is provided thereon with insertion pillars, with the insertion pillars being in cooperation with the insertion holes.

In any of the above-mentioned technical solutions, furthermore, contacting parts between the protective rotation shell and the housing of the vertical rotation part each are of a circular arc shape.

In any of the above-mentioned technical solutions, furthermore, both of an upper surface and a lower surface of the lateral plate are provided thereon with a position-limiting protrusion. Each of the position-limiting protrusions can abut against an inner wall of the protective rotation shell.

A second aspect of the present application provides a display supporter. The display supporter includes the rotation mechanism described in any of the above-mentioned technical solutions.

The display supporter provided in the second aspect of the present application is provided with the rotation mechanism provided in the first aspect. Thus, the displayer holder has all the beneficial effects of the rotation mechanism provided in the first aspect, which are not repeatedly described herein.

With the above-mentioned technical solutions, the present application has the beneficial effects as follows.

The rotation mechanism provided in embodiments of the present application is configured to be used for a display supporter. The rotation mechanism includes the holder, the horizontal rotation part and the vertical rotation part. One end of the vertical rotation part is rotationally connected with the holder via the rotation shaft, such that the vertical rotation part rotates about the rotation shaft in the vertical direction. One end of the horizontal rotation part is rotationally connected with the other end of the vertical rotation part via the connection shaft, such that the horizontal rotation part can rotate about the connection shaft in the horizontal direction. During use, if the vertical rotation is desired, the vertical rotation part is rotated around the rotation shaft to realize the rotation in the vertical direction; and if the horizontal rotation is desired, the horizontal rotation part is adjusted horizontally with a force to carry out the horizontal adjustment. In this way, the vertical rotation part and the horizontal rotation part are integrated together, which facilitates the adjustment and reduces the occupied space.

The additional aspects and advantages of the present application will become apparent from the following description or will be understood by practicing the present application.

### BRIEF DESCRIPTION OF DRAWINGS

In order to more clearly explain the technical solutions of the specific implementations of the present application or of the prior art, the drawings required for use in the specific implementations or the prior art will be introduced briefly below. It will be obvious that the drawings described below are merely some of the implementations of the present application, and those ordinarily skilled in the art would also obtain, from these drawings, other drawings without paying any inventive efforts.

FIG. 1 is a structural schematic view of a rotation mechanism arranged on a display supporter, provided in an embodiment of the present application;

FIG. 2 is a schematic view of a rotation mechanism arranged on a display supporter, from a viewing angle, provided in an embodiment of the present application;

FIG. 3 is a perspective structural schematic view of a rotation mechanism provided in an embodiment of the present application;

FIG. 4 is a perspective structural schematic view of the rotation mechanism shown in FIG. 3, with a housing removed;

FIG. 5 is a structural schematic view of the rotation mechanism shown in FIG. 3 from a viewing angle, with the housing removed;

FIG. 6 is a perspective structural schematic view of the rotation mechanism shown in FIG. 3, with the horizontal rotation part removed; and

FIG. 7 is a structural schematic view of the rotation mechanism shown in FIG. 3 from a viewing angle, with the horizontal rotation part removed.

### REFERENCE SIGNS

100—rotation mechanism; 10—holder; 11—connection base; 12—leg; 121—bayonet; 20—horizontal rotation part; 21—horizontal plate; 22—vertical plate; 23—insertion hole; 24—protective rotation shell; 30—vertical rotation part; 31—lateral plate; 311—position-limiting protrusion; 32—connection plate; 33—arc-shaped plate; 34—housing; 40—rotation shaft; 41—torsion spring; 50—connection shaft; 200—display supporter.

### DETAILED DESCRIPTION OF EMBODIMENTS

Technical solutions of the present application will be described clearly and completely hereinafter in conjunction with drawings. Apparently, the described embodiments are some of, but not all of the embodiments of the present application. Any other embodiments that were obtained by those ordinarily skilled in the art without any inventive effort based on the embodiments of the present application would fall within the scope of protection of the present application. It shall be noted that the embodiments and the features in the embodiments of the present application may be combined provided that there is no conflict.

It shall be noted that in the description of the present application, orientations or positional relations indicated by terms such as “center”, “upper”, “lower”, “left”, “right”, “vertical”, “horizontal”, “in”, and “out” are the orientations or positional relations shown based on the figures, which is only for the convenience of description of the present application and for the simplification of the description, rather than indicating or implying that the devices or elements must be in a particular orientation or constructed or operated in a particular orientation, and therefore these terms should not be construed as limiting the present application. In addition, terms such as “first”, “second”, and “third” are used only for the purpose of illustration, and shall not be construed as indicating or implying a relative importance.

It shall be noted that in the description of the present application, unless otherwise expressly specified or defined, terms “mounting”, “coupling”, and “connection” should be understood broadly. For example, a connection may be a fixed connection, or may also be a detachable connection, or an integrated connection; it may be a mechanical connection or may also be an electric connection; it may be a direct connection, or may also be a connection via an intermediate medium, or may be an internal communication between two elements. The specific meanings of the above-mentioned terms in the present application could be understood by those ordinarily skilled in the art according to specific situations.

The present application will be further explained and illustrated below in conjunction with the specific implementations.

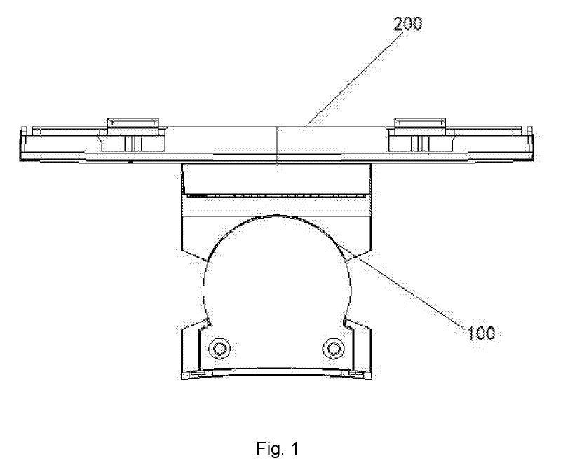

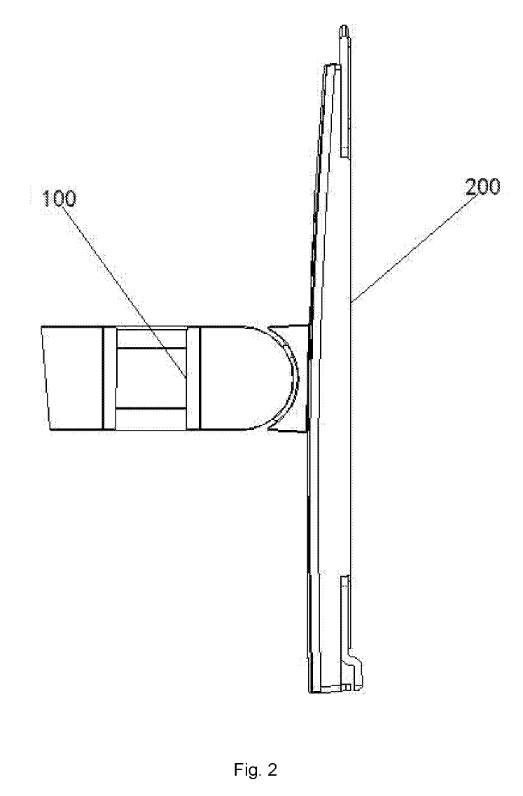

FIG. 1 is a structural schematic view of a rotation mechanism arranged on a display supporter, provided in an embodiment of the present application; FIG. 2 is a schematic view of a rotation mechanism arranged on a display supporter, from a viewing angle, provided in an embodiment of the present application;

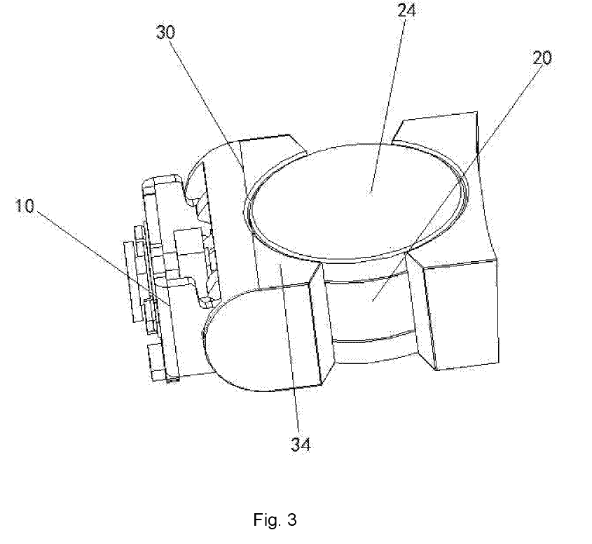

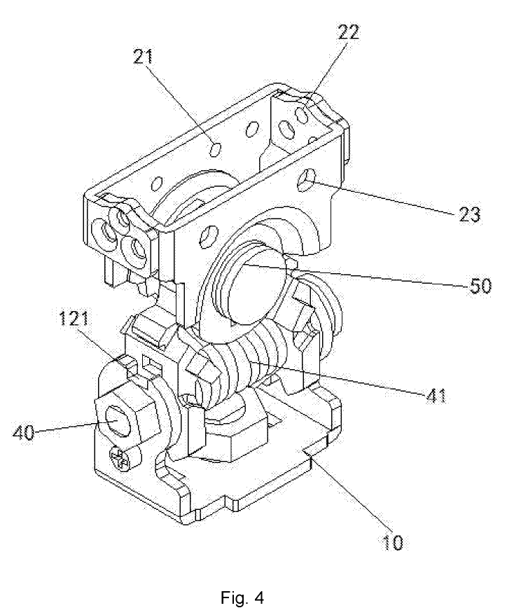

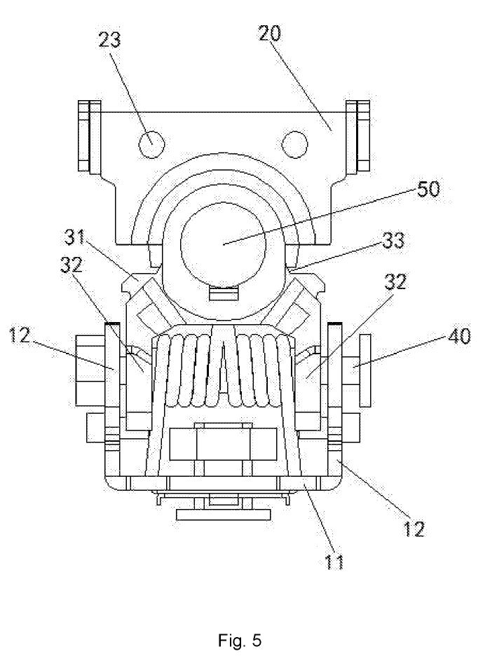

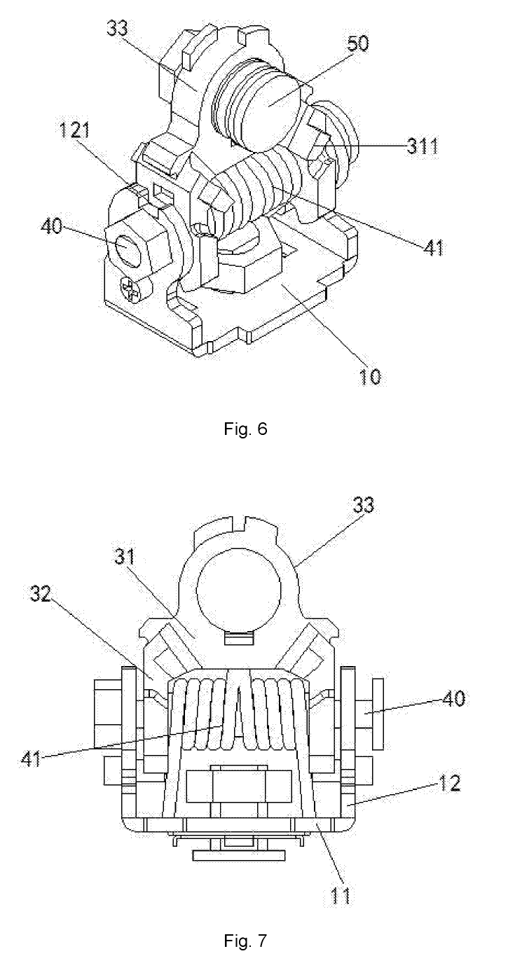

FIG. 3 is a perspective structural schematic view of a rotation mechanism provided in an embodiment of the present application; FIG. 4 is a perspective structural schematic view of the rotation mechanism shown in FIG. 3, with a housing removed; FIG. 5 is a structural schematic view of the rotation mechanism shown in FIG. 3 from a viewing angle, with the housing removed; FIG. 6 is a perspective structural schematic view of the rotation mechanism shown in FIG. 3, with the horizontal rotation part removed; and FIG. 7 is a structural schematic view of the rotation mechanism shown in FIG. 3 from a viewing angle, with the horizontal rotation part removed.

### First Embodiment

As shown in FIGS. 1-7, a rotation mechanism 100 provided in the present embodiment is configured to be used for a display supporter 200; and the rotation mechanism includes a holder 10, a horizontal rotation part 20 and a vertical rotation part 30.

One end of the vertical rotation part 30 is rotationally connected with the holder 10 via a rotation shaft 40, such that the vertical rotation part 30 rotates about the rotation shaft 40 in a vertical direction. One end of the horizontal rotation part 20 is rotationally connected with the other end of the vertical rotation part 30 via a connection shaft 50, such that the horizontal rotation part 20 can rotate about the connection shaft 50 in a horizontal direction.

The rotation mechanism 100 provided in an embodiment of the present application is configured to be used for the display supporter 200. The rotation mechanism includes the holder 10, the horizontal rotation part 20 and the vertical rotation part 30. One end of the vertical rotation part 30 is rotationally connected with the holder 10 via the rotation shaft 40, such that the vertical rotation part 30 rotates about the rotation shaft 40 in the vertical direction. One end of the horizontal rotation part 20 is rotationally connected with the other end of the vertical rotation part 30 via the connection shaft 50, such that the horizontal rotation part 20 can rotate about the connection shaft 50 in the horizontal direction. During use, if a vertical rotation is desired, the vertical rotation part 30 is rotated around the rotation shaft 40 to realize the rotation in the vertical direction; and if a horizontal rotation is desired, the horizontal rotation part 20 is adjusted horizontally with a force to carry out a horizontal adjustment. In this way, the vertical rotation part 30 and the horizontal rotation part 20 are integrated together, which facilitates the adjustment and reduces the occupied space.

In an optional implementation of the above embodiment, preferably, as shown in FIGS. 4-7, the vertical rotation part 30 includes one lateral plate 31, two connection plates 32 and an arc-shaped plate 33, with the two connection plates perpendicularly connected with two ends of the lateral plate 31, respectively, and the arc-shaped plate fixedly connected with a middle part of the lateral plate 31.

Each of the connection plates 32 is provided therein with a first through-hole. The rotation shaft 40 passes through each of a first connection hole in the holder 10 and the first through-holes and is connected with a nut, such that the two connection plates 32 are rotationally connected with the holder 10.

The arc-shaped plate 33 is provided therein with a second through-hole. The connection shaft 50 passes through a second connection hole of the horizontal rotation part 20 and is connected with a nut. The arc-shaped plate 33 is configured to cooperate with the horizontal rotation part 20, which plays a role of smooth transition.

In an optional implementation of the above embodiment, as shown in FIG. 5, the holder 10 includes a connection base 11 and legs 12, with the legs provided at two ends of the connection base 11. Each of the legs 12 is provided therein with the first connection hole.

Specifically, as shown in FIG. 5 and FIG. 6, an end of each of the legs 12 is provided with a bayonet 121. A housing 34 of the vertical rotation part 30 is provided thereon with a clamped pillar, with the clamped pillar being in cooperation with the bayonet 121, such that the housing 34 is connected with the holder 10.

Based on the aforementioned implementation, as shown in FIGS. 4-7, the rotation shaft 40 is provided thereon with a plurality of torsion springs 41. One end of each of the torsion springs 41 is stuck in the connection base 11, and the other end of each of the torsion springs is stuck in the lateral plate 31. In addition, each of the legs 12 is provided thereon with a limiting screw. The limiting screw can be positioned against an extended end of each of the torsion springs 41 by passing through the leg 12.

In this embodiment, one end of the rotation shaft 40 is provided with a plug, and the other end of the rotation shaft sequentially passes through the first connection hole of one of the legs 12, the first through-hole of one of the connection plates 32, and the two torsion springs 41, the first through-hole of the other connection plate 32, and the first connection hole of the other leg 12. One end of each of the torsion springs 41 is stuck in the connection base 11, and the other end of each of the torsion springs 41 is stuck in the lateral plate 31. The structure is simple and enables an easy operation of the torsion springs. Meanwhile, the torsion springs 41 can restore the vertical rotation part 30 back to an initial position for an easy use.

Based on the aforementioned embodiment, as shown in FIG. 4, the horizontal rotation part 20 includes two horizontal plates 21 arranged to each other. The two horizontal plates 21 are connected with each other via two vertical plates 22. Each of the vertical plates 22 is arranged at an end of edge portion of each of the horizontal plates 21. Each of the horizontal plates 21 is provided therein with the second connection hole.

Specifically, the horizontal plates 21 are provided therein with a plurality of insertion holes 23, and a protective rotation shell 24 is provided on the horizontal plates 21. The rotation shell is provided thereon with insertion pillars, with the insertion pillars being in cooperation with the insertion holes 23.

With a further improvement, contacting parts between the protective rotation shell 24 and the housing 34 of the vertical rotation part 30 each are of a circular arc shape, such that the vertical rotation part moves along the circular arc shape during the rotation, which facilitates the rotation.

With a still further improvement, as shown in FIG. 4 and FIG. 6, both of an upper surface and a lower surface of the lateral plate 31 are provided thereon with a position-limiting protrusion 311. Each of the position-limiting protrusions 311 can abut against an inner wall of the protective rotation shell 24.

In the case that the protective rotation shell 24 rotates, the inner wall can move along the position-limiting protrusion 311, where the protective rotation shell 24 serves a function of limitation.

### Second Embodiment

As shown in FIG. 1 and FIG. 2, a display supporter 200 provided in the second embodiment of the present application includes the rotation mechanism 100 described in any of the implementations of the abovementioned first embodiment. The holder 10 may be arranged on a base of the display supporter 200 via a bolt.

The display supporter 200 provided in the second embodiment of the present application is configured with the rotation mechanism 100 provided in the first embodiment. Thus, the displayer holder has all the beneficial effects of the rotation mechanism provided in the first embodiment, which are not repeatedly described herein.

In conclusion, the rotation mechanism provided in the embodiments of the present application is configured to be used for the display supporter. The rotation mechanism includes the holder, the horizontal rotation part and the vertical rotation part. One end of the vertical rotation part is rotationally connected with the holder via the rotation shaft, such that the vertical rotation part rotates about the rotation shaft in the vertical direction. One end of the horizontal rotation part is rotationally connected with the other end of the vertical rotation part via the connection shaft, such that the horizontal rotation part can rotate about the connection shaft in the horizontal direction. During use, if the vertical rotation is desired, the vertical rotation part is rotated about the rotation shaft to realize the rotation in the vertical direction; and if the horizontal rotation is desired, the horizontal rotation part is adjusted horizontally with a force to carry out the horizontal adjustment. In this way, the vertical rotation part and the horizontal rotation part are integrated together, which facilitates the adjustment and reduces the occupied space.

Finally, it shall be noted that the above embodiments are merely intended to explain the technical solutions of the present application, rather than limiting the present application. Although the present application is explained in detail with reference to the foregoing embodiments, it should be understood by those ordinarily skilled in the art that the technical solutions described in the foregoing embodiments may still be modified, or that some or all of the technical features thereof may be substituted by equivalent alternatives; and these modifications or substitutions will not make the gist of the corresponding technical solutions depart from the scope of the technical solutions of various embodiments of the present application. In addition, it would be understood by those skilled in the art that although some of the embodiments described herein include certain features that are included in other embodiments instead of other features, combinations of the features of different embodiments are intended to fall into the scope of the present application and form different embodiments. For example, in the following claims, any of the claimed embodiments may be implemented in any combination. The information disclosed in the Background Art is intended only to deepen the understanding of the general background art of the present application and shall not be considered as admitting or implying in any manner that the information constitutes prior art known to those skilled in the art.

1. A rotation mechanism, configured to be used for a display supporter, wherein the rotation mechanism comprises a holder, a horizontal rotation part and a vertical rotation part,
wherein one end of the vertical rotation part is rotationally connected with the holder via a rotation shaft, such that the vertical rotation part rotates about the rotation shaft in a vertical direction; and one end of the horizontal rotation part is rotationally connected with the other end of the vertical rotation part via a connection shaft, such that the horizontal rotation part can rotate about the connection shaft in a horizontal direction.

2. The rotation mechanism according to claim 1, wherein the vertical rotation part comprises one lateral plate, two connection plates and an arc-shaped plate, with the two connection plates perpendicularly connected with two ends of the lateral plate, respectively, and the arc-shaped plate fixedly connected with a middle part of the lateral plate;
each of the connection plates is provided therein with a first through-hole, and the rotation shaft passes through each of a first connection hole in the holder and the first through-holes and is connected with a nut, such that the two connection plates are rotationally connected with the holder; and
the arc-shaped plate is provided therein with a second through-hole, and the connection shaft passes through a second connection hole of the horizontal rotation part and is connected with a nut.

3. The rotation mechanism according to claim 2, wherein the holder comprises a connection base and legs with the legs provided at two ends of the connection base, and each of the legs is provided therein with the first connection hole.

4. The rotation mechanism according to claim 3, wherein an end of each of the legs is provided with a bayonet, and a housing of the vertical rotation part is provided thereon with a clamped pillar with the clamped pillar being in cooperation with the bayonet, such that the housing is connected with the holder.

5. The rotation mechanism according to claim 3, wherein the rotation shaft is provided thereon with a plurality of torsion springs, one end of each of the torsion springs is stuck in the connection base, and the other end of each of the torsion springs is stuck in the lateral plate.

6. The rotation mechanism according to claim 2, wherein the horizontal rotation part comprises two horizontal plates arranged opposite to each other, the two horizontal plates are connected with each other via two vertical plates, and each of the vertical plates is arranged at an end of edge portion of each of the horizontal plates; and each of the horizontal plates is provided therein with the second connection hole.

7. The rotation mechanism according to claim 6, wherein the horizontal plates are provided therein with a plurality of insertion holes, a protective rotation shell is provided on the horizontal plates, and the rotation shell is provided thereon with insertion pillars, with the insertion pillars being in cooperation with the insertion holes.

8. The rotation mechanism according to claim 7, wherein contacting parts between the protective rotation shell and a housing of the vertical rotation part each are of a circular arc shape.

9. The rotation mechanism according to claim 7, wherein both of an upper surface and a lower surface of the lateral plate are provided thereon with a position-limiting protrusion, and each of the position-limiting protrusions can abut against an inner wall of the protective rotation shell.

10. A display supporter comprising the rotation mechanism according to claim 1.

11. The display supporter according to claim 10, wherein the vertical rotation part comprises one lateral plate, two connection plates and an arc-shaped plate, with the two connection plates perpendicularly connected with two ends of the lateral plate, respectively, and the arc-shaped plate fixedly connected with a middle part of the lateral plate;
each of the connection plates is provided therein with a first through-hole, and the rotation shaft passes through each of a first connection hole in the holder and the first through-holes and is connected with a nut, such that the two connection plates are rotationally connected with the holder; and
the arc-shaped plate is provided therein with a second through-hole, and the connection shaft passes through a second connection hole of the horizontal rotation part and is connected with a nut.

12. The display supporter according to claim 11, wherein the holder comprises a connection base and legs with the legs provided at two ends of the connection base, and each of the legs is provided therein with the first connection hole.

13. The display supporter according to claim 12, wherein an end of each of the legs is provided with a bayonet, and a housing of the vertical rotation part is provided thereon with a clamped pillar with the clamped pillar being in cooperation with the bayonet, such that the housing is connected with the holder.

14. The display supporter according to claim 12, wherein the rotation shaft is provided thereon with a plurality of torsion springs, one end of each of the torsion springs is stuck in the connection base, and the other end of each of the torsion springs is stuck in the lateral plate.

15. The display supporter according to claim 11, wherein the horizontal rotation part comprises two horizontal plates arranged opposite to each other, the two horizontal plates are connected with each other via two vertical plates, and each of the vertical plates is arranged at an end of edge portion of each of the horizontal plates; and each of the horizontal plates is provided therein with the second connection hole.

16. The display supporter according to claim 15, wherein the horizontal plates are provided therein with a plurality of insertion holes, a protective rotation shell is provided on the horizontal plates, and the rotation shell is provided thereon with insertion pillars, with the insertion pillars being in cooperation with the insertion holes.

17. The display supporter according to claim 16, wherein contacting parts between the protective rotation shell and a housing of the vertical rotation part each are of a circular arc shape.

18. The display supporter according to claim 16, wherein both of an upper surface and a lower surface of the lateral plate are provided thereon with a position-limiting protrusion, and each of the position-limiting protrusions can abut against an inner wall of the protective rotation shell.
